(19) United States
(12) Patent Application Publication
(10) Pub. No.: US 2011/0132372 A1
(43) Pub. Date: Jun. 9, 2011

(54) INTRA-NASAL AIR FILTRATION DEVICES AND METHODS

(76) Inventor: William Goodhew, Ithaca, NY (US)

(21) Appl. No.: 12/632,096

(22) Filed: Dec. 7, 2009

(51) Int. Cl. A62B 7/10; D04H 1/70

(52) U.S. Cl. 128/206.11; 28/122

(57) ABSTRACT

An intra-nasal air filtration device includes a filter material. The filter material is sized to fit a nasal vestibule of a user, is resilient such that it expands after compression for insertion into the nasal vestibule, and blocks passage of airborne particles while permitting passage of air during inhalation by the user. The filter material preferably includes a plurality of synthetic fibers. In some embodiments, the filter material has a density and texture similar to that of a natural sea sponge. In some embodiments, particles of activated charcoal are bonded to the fibers and a synthetic fabric is bonded to at least a portion of an outer surface of the synthetic fibers. A method of manufacturing an intra-nasal air filtration device, a method of filtering airborne particles from an air stream, and a method of enhancing breathing of an individual are also disclosed.

### BACKGROUND OF THE INVENTION

1. Field of the Invention

The invention pertains to the field of air filters. More particularly, the invention pertains to a breathing air filter placed in an intra-nasal cavity of the user.

2. Description of Related Art

Air filter devices for mitigating breathing in environments containing dust, dirt, allergens, airborne pathogens, and other airborne impurities are known in the art. Dust masks and other external devices provide protection to the user but can limit the user's ability to work in the environment. For example, dust masks commonly direct exhalation gases to a user's eyeglasses, causing them to fog temporarily.

Conventional air filters mounted substantially in the nasal vestibules avoid these problems but they can be uncomfortable and difficult to fit properly and can reduce the airflow capacity of the nostrils. For example, U.S. Pat. No. 5,117,820, issued Jun. 2, 1992 to Robitaille, discloses a cylindrical intra-nasal filter of a synthetic spongy material, where a vacuum is required to compress the material sufficiently for proper insertion into the nostril, but no further details on the material composition are provided. U.S. Pat. No. 6,971,387, issued Dec. 6, 2005 to Michaels, discloses a personal air purifier of two foam semi-cylinders connected by a flexible band to prevent over-insertion and to aid in removal. There is a need in the art for an intra-nasal air filter that is comfortable to wear and is effective at removing airborne particles without inhibiting airflow during both intake and exhalation when breathing.

### SUMMARY OF THE INVENTION

An intra-nasal air filtration device includes a filter material. The filter material is sized to fit a nasal vestibule of a user, is resilient such that it expands after compression for insertion into the nasal vestibule, and blocks passage of airborne particles while permitting passage of air during inhalation by the user. The filter material preferably includes a plurality of synthetic fibers. In some embodiments, the filter material has a density and texture similar to that of a natural sea sponge. In some embodiments, particles of activated charcoal are bonded to the fibers and a synthetic fabric is bonded to at least a portion of an outer surface of the synthetic fibers. A method of manufacturing an intra-nasal air filtration device, a method of filtering airborne particles from an air stream, and a method of enhancing breathing of an individual are also disclosed.

In one embodiment, the intra-nasal air filtration device includes a filter material including a plurality of synthetic fibers. The filter material is sized to fit a nasal vestibule of a user and is resilient such that the filter material expands toward an original shape after compression. The filter material blocks passage of airborne particles while permitting passage of air therethrough during inhalation by the user.

In another embodiment, a method of manufacturing an intra-nasal air filtration device includes manufacturing a plurality of synthetic fibers into a shape sized to fill a nasal vestibule of a human user.

In yet another embodiment, a method of filtering airborne particles from an air stream includes placing a filter device including a plurality of non-woven, open mesh nylon fibers in a conduit and driving the air stream through the conduit.

In another embodiment, a method of enhancing breathing of an individual includes sizing a plurality of synthetic fibers such that the fibers fill a nasal vestibule of the individual and expand a portion of a nasal passage of the individual. The method also includes placing the plurality of synthetic fibers in the nasal vestibule of the individual.

### BRIEF DESCRIPTION OF THE DRAWINGS

FIG. 1 shows a perspective view of an air filter in an embodiment of the present invention.

FIG. 2 shows a cross sectional view of the air filter of FIG. 1 fitted inside a nose.

FIG. 3 shows a perspective view of an air filter with activated charcoal bonded to the fibers and fabric bonded to the ends in an embodiment of the present invention.

### DETAILED DESCRIPTION OF THE INVENTION

A device of the present invention provides air filtration to a user during breathing inhalation through the nose while being comfortable to wear and not impeding the user's ability to see, move, breathe, talk, or work while using the device. The device is easily placed securely in the nostril, is readily adjusted for a desired fit, and may be cleaned and re-used to extend its use. The device preferably expands the nasal passage when properly placed in the nose without inhibiting airflow through the nostril and may reduce or eliminate snoring during the user's sleep.

As used herein, “nostrils” refers to the external orifices of the nose, “nasal vestibules” refers to the most anterior parts of the nasal cavity, specifically the void space formed by the cartilages of the nose and accessible by the nostrils, and “nasal passages” refers to the air passages connecting the nasal vestibules to the upper part pharynx.

As used herein, “manually compressible” refers to the ability of a material to be compressed between adult human fingers.

As used herein, “synthetic fibers” refers to man-made materials that are continuous filaments or are in discrete elongated pieces. Synthetic fiber materials include, but are not limited to, petrochemical-based materials, cellulose-based materials, including rayon, modal, and Lycocell, fiberglass, carbon fibers, and polymer fibers, including, but not limited to, nylon, polyamide nylon, polyethylene terephthalate (PET), polybutylene terephthalate (PBT), phenol-formaldehyde (PF), polyvinyl alcohol fiber (PVA), polyvinyl chloride fiber (PVC), polyolefins, including polypropylene and polyethylene, acrylic polyesters, aromatic polyamids, elastomers, and polyurethane.

An intra-nasal air filter device of the present invention preferably is formed to provide a secure fit when placed in the user's nostril, is comfortable for several hours of consecutive use, opens the nasal passages to allow a large volume of airflow, is cleanable and reusable, is easily installed and removed, and mitigates snoring in the user.

The device includes a filter material, which is preferably a plurality of fibers formed in a cylindrical shape. In some embodiments, the fibers are synthetic. The filter material preferably easily compresses to allow quick placement in the nostril. When properly placed, the device preferably extends from the entrance of the nasal vestibule to a portion of the nasal passage. The fibers are preferably resilient, returning to their original size and shape after compression. After compression and placement in the nasal vestibule, the device expands to fit the contours of the nasal vestibule and gently enlarges the contact areas of the nasal passages. This radial expansion promotes a snug fit and enhanced breathing. In one embodiment, a method of enhancing breathing of an individual includes sizing a plurality of synthetic fibers such that the fibers fill a nasal vestibule of the individual and expand a portion of a nasal passage of the individual. The method also includes placing the plurality of synthetic fibers in the nasal vestibule of the individual.

The fibers trap dust, pollen, and other airborne particles. Normal breathing through the nose with the device in place promotes a partial cleaning of the filter material with each exhalation. Specifically, some of the airborne particles blocked by the filter material during an inhalation are subsequently expelled during an exhalation. If, upon continued use of the device, enough airborne particles remain in the filter material such that the airflow capacity begins to decrease, the device may be removed from the nose, cleaned, and returned to the nose for continued use. Methods of cleaning the device include, but are not limited to, applying a disinfectant to the device and washing the device with soap and water.

In a preferred embodiment, the filter material is a synthetic fiber material marketed as Norton® BEAR-TEX® 54-LINE plus floor maintenance pads, #57601, manufactured by Saint-Gobain Abrasives, Inc. (Stephenville, Tex.). In a preferred embodiment, devices of the present invention are die-cut from such a floor maintenance pad. The floor maintenance pads are currently manufactured for use in high gloss buffering or burnishing of floors and are sold as cylindrical disks having a thickness of about one inch and a diameter of about 15½ inches and weighing about 2.7 ounces. The pads have a bulk density of about 0.00693 pounds per cubic inch in an uncompressed state. In other embodiments, the synthetic fibers have a bulk density between about 0.006 and about 0.008 pounds per cubic inch in an uncompressed state. The fibers are manually compressible to about ⅛^{th} of their thickness and return to more than 90% of their original thickness within one second of removal of a manual compression force. The fibers are fairly dense so as to be able to expand the nasal cavity but not coarse or abrasive. Consequently, they are comfortable in the nostril. The material preferably has an open mesh construction of a non-woven web of nylon fibers and is preferably non-loading. In some embodiments, the synthetic fibers may be loaded or mixed with one or more non-fibrous material, including, but not limited to, an abrasive material, activated charcoal, or a fragrant material.

In a preferred embodiment, the intra-nasal air filtration device consists of only the filter material including the plurality of synthetic fibers and optionally one or more non-fibrous material. In this embodiment, there is no covering such as a plastic housing and no nose clip or other auxiliary structure to keep the device in place during use.

In some embodiments of the present invention, the device includes particles of activated charcoal and an outer layer of fabric. In some embodiments, the filter material is the same as the filter material previously described. In other embodiments, the filter material is a known air filter material. In one embodiment, the filter material is a non-woven polyester material incorporating activated charcoal available from Air Filters, Inc. (Houston, Tex.). The activated charcoal may be bonded to or trapped in the filter material.

The activated charcoal mitigates airborne odors and absorbs smoke during use. In some embodiments, the fabric is synthetic. The fabric may completely encase the fibers and particles of activated charcoal or cover primarily only the ends of the device.

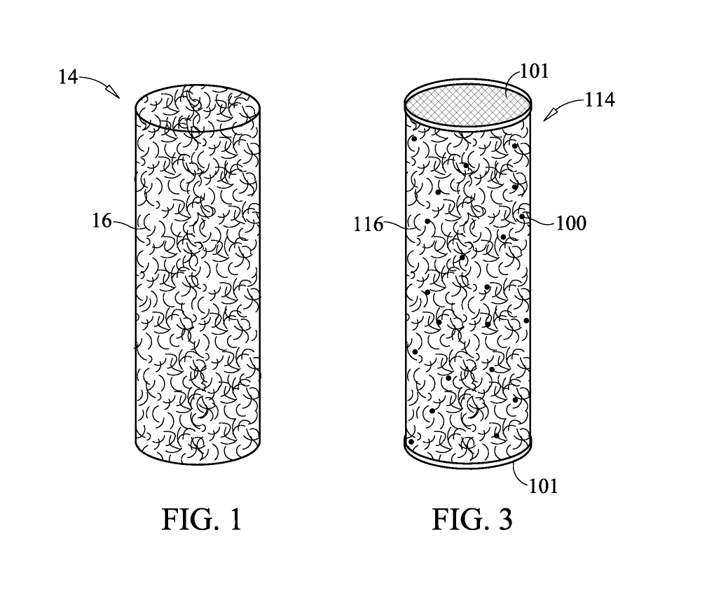

FIG. 1 shows an intra-nasal filter device 14 in a first embodiment of the present invention. The filter 14 has a generally cylindrical shape sized and is proportioned to fit snugly but comfortably in a human nasal vestibule. The cylindrical body of the filter 14 is made of a filter material 16, which blocks or captures airborne particles but does not impede airflow. The filter material is preferably a plurality of resilient synthetic fibers.

FIG. 2 shows the filter 14 positioned in a nostril 12 of the nose 13. The filter is preferably designed to be placed in a single nostril with separate filters being placed in each nostril to provide filtration during breathing. The filter preferably extends from just outside the nostril 12 through the nasal vestibule 11, terminating at the nasal passage 10 when properly sized and positioned. In one embodiment, the filter is about one inch in length and three-eighths of an inch in diameter. In another embodiment, the filter is about one inch in length and half an inch in diameter.

Each filter device of the present invention may be directly inserted into each nostril by pushing the filter device into position by the user with the user's fingers. Alternatively, each filter device may be twisted or pulled prior to insertion or after insertion to adjust its position for a comfortable fit. The filters may be compressed slightly by rolling the length of the fiber cylinder between the thumb and forefinger prior to insertion into the nasal vestibule. The fibers return to substantially their full original size, preferably within a few minutes or less. In some embodiments, the fibers revive to at least 90% of their original size within a few seconds or less. Once in place, the filter gently presses the contact areas of the nostril, the nasal vestibule, and the nasal passage to provide a firm placement that is not easily disturbed by the process of breathing through the nose. Additionally, the filter preferably expands the nasal passage, allowing greater volumetric flow of air during inhalation and exhalation.

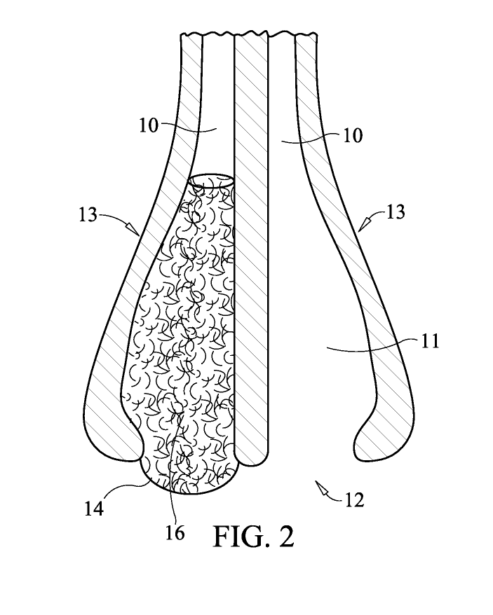

FIG. 3 shows an intra-nasal air filter device 114 in a second embodiment of the present invention. Small particles of activated charcoal 100 are bonded with or trapped by the filter material 116 of the filter 114. The filter material 116 may be the same as the filter material 16 in the first embodiment or may be a different material within the spirit of the present invention. A light fabric of cloth 101 preferably covers or is bonded to one or both of the ends of the cylinder. The activated charcoal mitigates airborne odors and absorbs smoke, and the cloth prevents inhalation of loose charcoal particles during use of the air filter device.

In some embodiments of the present invention, the filter device is sized to fit the nostril of the user. For example, the device may come in small, medium, and large sizes. In some embodiments, the device is not cylindrical in shape but instead is contoured to the shape of the nasal vestibule to provide a substantially uniform fit along the length of the vestibule. Filters of the present invention may alternatively have tetrahedral, conical, cubical, rectangular, or spherical shapes, although cylindrical shapes appear to provide the most comfortable fit. In some embodiments, one end of the device is designed to be placed at or near the entrance to the nasal passage and is formed to be able to apply enough pressure to the nasal passage walls to widen the nasal passage for better airflow through the nasal passage.

Any material having the following characteristics may be used in a device of the present invention within the spirit of the present invention. The material prevents airborne particles, particularly dust, from entering the nasal passage while permitting airflow. Preferable materials include synthetic fibers with a high enough fiber density to block airborne particles but a low enough fiber density to minimally reduce airflow to the nasal passage. The material is resiliently compressible for placement into, maintenance in, and removal from the nasal vestibule. In a preferred embodiment the material is manually compressible with the fingers without the use of any vacuum or mechanical tool to remove void space to compress the fibers for insertion into the nose. The material is also flexible enough to be comfortable in the nose for long periods of time.

Although the filter materials described herein have been described for use in intra-nasal air filtration devices, the materials may be used for filtration of any air stream flowing through any conduit within the spirit of the present invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An intra-nasal air filtration device comprising a filter material comprising a plurality of synthetic fibers, wherein the filter material is sized to fit a nasal vestibule of a user, wherein the filter material is resilient such that the filter material expands toward an original shape of the filter material after compression, and wherein the filter material blocks passage of airborne particles while permitting passage of air therethrough during inhalation by the user.

2. The intra-nasal air filtration device of claim 1, wherein the filter material has a substantially cylindrical shape and wherein the device includes no covering for the filter material.

3. The intra-nasal air filtration device of claim 1 further comprising a plurality of activated charcoal particles bonded to the plurality of synthetic fibers.

4. The intra-nasal air filtration device of claim 3 further comprising a fabric cloth covering at least a portion of the outer surface of the filter material.

5. The intra-nasal air filtration device of claim 4, wherein the fabric cloth comprises a synthetic fabric material.

6. The intra-nasal air filtration device of claim 1, wherein the device is cleanable to remove airborne particles from the filter material and reusable.

7. The intra-nasal air filtration device of claim 1, wherein the synthetic fibers are made of a material selected from the group consisting of: a petrochemical-based material, a cellulose-based material, rayon, modal, Lycocell, fiberglass, carbon, a polymer fiber, nylon, polyamide nylon, polyethylene terephthalate, polybutylene terephthalate, phenol-formaldehyde, polyvinyl alcohol, polyvinyl chloride, a polyolefin, polypropylene, polyethylene, an acrylic polyester, an aromatic polyamid, an elastomer, and polyurethane.

8. The intra-nasal air filtration device of claim 1, wherein the synthetic fibers are non-woven, open mesh nylon fibers.

9. The intra-nasal air filtration device of claim 8, wherein the nylon fibers have a density between about 0.006 and about 0.008 pound per cubic inch in an uncompressed state and are manually compressible to at least ⅛^{th} of their thickness in the uncompressed state.

10. The intra-nasal air filtration device of claim 8, wherein the nylon fibers are formed such that the nylon fibers return to a thickness that is at least 90% of the thickness of the nylon fibers in an uncompressed state within one second of removal of a manual compression force.

11. A method of manufacturing an intra-nasal air filtration device, the method comprising the step of manufacturing a plurality of synthetic fibers into a shape sized to fill a nasal vestibule of a human user.

12. The method of claim 11 further comprising the step of bonding a plurality of active charcoal particles to the synthetic fibers.

13. The method of claim 12 further comprising the step of bonding a synthetic fabric to at least a portion of an outer surface of the plurality of synthetic fibers.

14. The method of claim 11, wherein the plurality of synthetic fibers are non-woven, open mesh nylon fibers having a density between about 0.006 and about 0.008 pound per cubic inch in an uncompressed state.

15. A method of filtering airborne particles from an air stream, the method comprising the steps of:
a) placing a filter device comprising a plurality of non-woven, open mesh nylon fibers in a conduit; and
b) driving the air stream through the conduit.

16. The method of claim 15, wherein the filter device comprises an intra-nasal air filtration device, the conduit comprises a nostril of a user, and the air stream comprises an inhalation breath of the user.

17. The method of claim 16, wherein the filter device is sized to fit the nasal vestibule of the user, wherein the plurality of synthetic fibers is resilient such that the synthetic fibers expand after compression for insertion into the nasal vestibule, and wherein the synthetic fibers block passage of airborne particles while permitting passage of air therethrough during inhalation by the user.

18. The method of claim 15 further comprising the steps of compressing the filter device prior to step a).

19. The method of claim 15 further comprising the steps:
c) removing the filter device from the air stream;
d) cleaning the filter device; and
e) re-placing the filter device in the conduit.
